(19) United States
(12) Patent Application Publication
(10) Pub. No.: US 2001/0004438 A1
(43) Pub. Date: Jun. 21, 2001

(54) Turbo-vibrator

(76) Inventor: Thomas Reis, Albig (DE)

Correspondence Address: John F. McNulty, Paul & Paul, 2900 Two Thousand Market Street, Philadelphia, PA, 19103, US

(21) Appl. No.: 09/737,415

(22) Filed: Dec. 15, 2000

(30) Foreign Application Priority Data
Dec. 21, 1999 (DE) 299 22 369.8

(51) Int. Cl. B06B 1/16; B06B 1/18

(52) U.S. Cl. 415/202; 366/124

(57) ABSTRACT

With the aim of enhancing the efficiency of pneumatically driven vibrators, with an essentially closed casing (2), in whose operating space (3) a cylindrically-shaped, unbalanced rotor (1) is mounted in bearings in such a way as to be capable of rotation, and which exhibits a channel for inflow and outflow (4, 5) that is at least tangentially directed in relation to this rotor (1), so as to allow for an air-driven mode of operation, it is intended-in accordance with this invention-that the cross-section of the pneumatic stream that flows from every inflow channel (4), between the exterior surface of the rotor (1) and the inner wall of the operating space (3), should first be steadily reduced-in the direction of the current-down to the narrowest cross-section, and then be steadily increased, up to the corresponding outflow channel (5).

A cross-section of pneumatic current that is formed in this fashion, with a cylindrically-shaped operating space (3), can be achieved through the arrangement of the axis (6) of the rotor (1) eccentrically relative to the axis (7) of the operating space (3). This can also be accomplished by the adaptation of the operating space of the housing, either by means of an insert or through an opening correspondingly opposite to the cylinder-shaped fundamental form.

In a manner that is altogether familiar per se, the rotor is equipped with axial bore holes [drillings] (13), that can be utilized for the purpose of setting, as well as for the alteration of, its unbalance.

The invention involves a pneumatically driven turbo-vibrator, with an essentially closed housing, within whose operating space a cylinder-shaped, unbalanced rotor is mounted in bearings in such a way as to be capable of rotation. Moreover, the afore-mentioned housing exhibits a channel for inflow and outflow that is at least tangentially positioned in relation to this rotor, so as to allow for an air-driven mode of operation.

A vibrator of this sort, for example, has become quite familiar from the case of DE 43 07 483 C2 (in accordance with U.S. Pat. No. 5,314,305). This exterior surface of the rotor, which in its basic form is cylinder-shaped is, as seen in cross-section, saw-tooth-shaped in formation in order to provide a larger target for the pneumatic medium of kinetic energy, which flows through the operating space, i.e., from the inflow channel to the outflow channel. This saw-tooth formation of the exterior surface of the rotor is also for the purpose of improving efficiency. Such a vibrator is therefore called a “turbo-vibrator.” In this well-known vibrator, the interior wall of the operating space is also cylindrical in formation, so that the cross-section of the pneumatic stream-from the inflow channel all the way through the outflow channel-is everywhere constant between the rotor, that is mounted within the housing (in concentric relation to the operating space), and the interior wall of the rotor. In moving through this operating space, the energy of the pneumatic stream can be optimally transmitted onto the rotor only to a limited extent, and with vibrators of this sort only moderate degrees of efficiency as regards energy utilization can be achieved.

The task to be accomplished through innovation is that of improving a pneumatically driven vibrator of the sort mentioned at the outset, and of improving it specifically in such a way that the pressure exerted by the pneumatic stream can be put to better use, and so that this pressure of the pneumatic stream may also be converted into the kinetic energy of the rotor, with a higher degree of efficiency.

In order to accomplish this task, it is intended in the present invention that the cross-section of the pneumatic stream that flows from every inflow channel, between the exterior surface of the rotor (1) and the inner wall of the operating space (3), should first be steadily reduced-in the direction of the current-down to the narrowest cross-section, and then be steadily increased, up to the corresponding outflow channel.

It has been established that-through re-designing the cross-section of the pneumatic current in this fashion-the efficiency of the vibrator can be considerably improved. When compared with other vibrators that are similar as regards their size, and that reflect the current state of development in technology, substantially higher speeds can be attained with same throughput of air. Conversely, at identical speeds, with a lower throughput of kinetic energy, a higher work output from the rotor can be achieved.

An increase in the speed of the pneumatic stream is enforced, by means of a formation of the cross-section, as set forth in the invention; this increase in speed is initially effectuated through the application of constant pressure. Moreover, through this increase in speed, the energy of the pneumatic stream can be optimally transmitted onto the rotor over a more extensive region. In connection with the narrowest cross-section, the pneumatic stream can steadily expand. Wholly apart from the enhancement of efficiency, a reduction in noise level is thereby also attained.

Advantageous design features of the invention are described below in claims 2 to 13. Additional details will be minutely explained, with the help of the examples set forth in FIGS. 1 to 3.

It shows:

FIG. I a cross-section of a vibrator with a side view of the rotor.

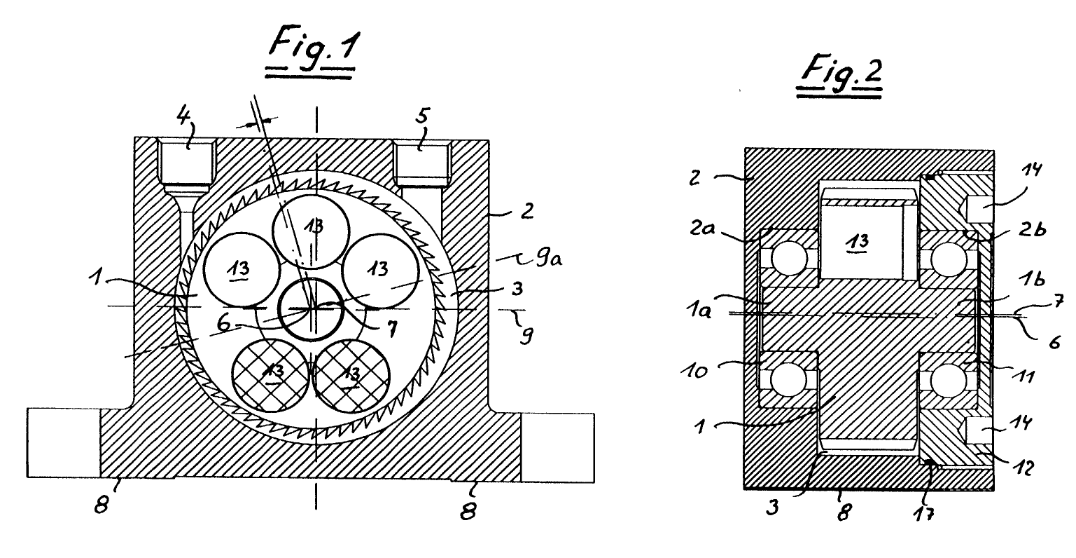

FIG. 2 a cut through the vibrator as in FIG. 1 lengthwise, and

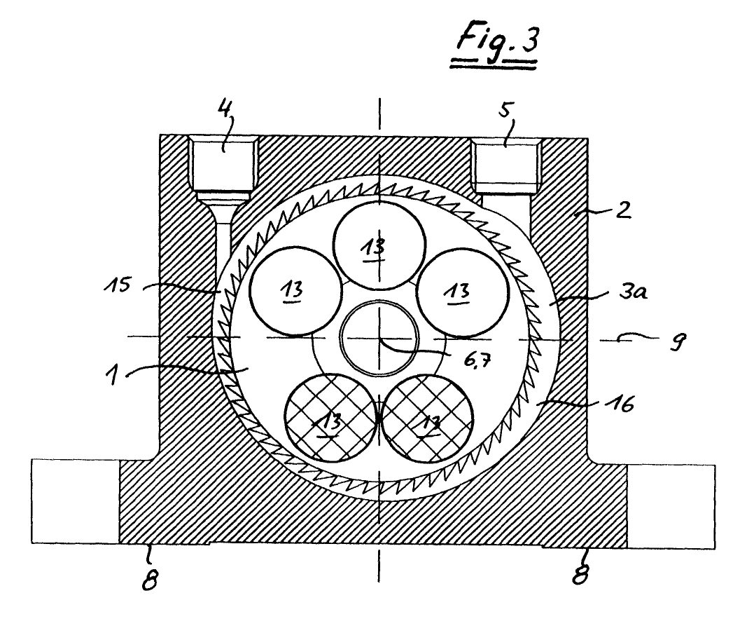

FIG. 3 a cross-section through an additional vibrator form with a side view of the rotor.

In the example implementation represented in FIG. 1, the housing has an approximately square cross-section, with a one-piece fortification flange attached below, whose mounting surface 8 lies opposite to the connection clips of an inflow channel 4 and an outflow channel 5. In the housing 2, there is a cylindrically shaped operating space 3, whose axis 7 lies on a plane 9 that runs parallel to the mounting surface. Axis 6 of the rotor 1 proceeds in parallel fashion relative to axis 7 of the housing 3; it is, however, mounted to the left and downward opposite the axis 7 around the amount E. Through it, both axes 6 and 7 lie on a plane, 9a, that is turned in a counter clockwise manner in relation to plane 9. In the implementation example that is represented, the revolution amounts to approximately 15 degrees. Through this eccentric positioning of the fundamentally cylinder-shaped rotor 1 in to the equally cylinder-shaped operative space 3 the following result is achieved: The cross-section of the pneumatic stream that is present between the exterior surface of the rotor 1 and the interior wall of the operative space 3, is (from the outflow channel 4) first steadily reduced-in the direction of the current-down to the narrowest cross-section, and is then steadily increased, up to the outflow channel 5. The narrowest cross-section lies in the area, in which plane 9a intersects with the exterior surfaces of the rotor 1 and of the operating space 3. In the rotor, 1 there are formed bores 13 that run parallel to the axis; these bores in manner in itself familiar can be filled in with a material, whose specific weight is greater than that of the rotor material. Five bores 13 are represented, that are unevenly distributed in the extent of their circumferences.

From the cross-section representation, as set forth in FIG. 2, the bearing pins 1a and 1b of rotor 1, that are lodged in bores 2a and 2b by means of ball-bearings 10 and 11 can be seen. The axis 7 of the housing lies in the cross-sectional plane and in plane 9. The axis 6 of the rotor lies below plane 9 and before the cross-sectional plane in 1. Above the axes 6 and in 7, an axial bore 13 is to be seen in the rotor, in which a determinate filling can be arranged for the setting of the rotor imbalance.

While the ball-bearing 13 to the right in the representation is lodged directly in bore 2a of the housing 2, the ball-bearing 11 to the right in the representation, is taken up by a bore 2b of a cover 12, that is screwed in into the housing 2. For purposes of disassembly an appropriate mechanism can be inserted into the dead end bores 14 of the cover 12, and this can be turned out from the housing. O-Ring, 17, is used for the insulation between housings, 2, and covers, 12.

In the implementation example that is present in FIG. 3 the axes 6 and 7 coincide. In this implementation example, both the increase and the decrease of the cross-section for the streaming pneumatic work medium, as characterized in the invention, is reached by virtue of the fact that the cylindrical essential form of the operative space 3a is modified by openings 15, 16. At that point, the opening 15, which is located toward the beginning, is formed in such a way that the desired diminution of the current cross-section proceeds on an ongoing basis until it reaches a narrowest cross-section. The opening 16 provides a cross-section of pneumatic current that steadily widens itself in an ongoing fashion from the narrowest place all the way up to the outflow channel 5. In this cross-section of pneumatic current, in the figures in the streaming work medium can expand continually, without any excessive sound development occurring. The remaining reference numbers in FIG. 3 correspond to those in FIGS. 1 and 2, and do not require any ether explanation.

The new formation is accordingly valid for the course of the cross-section of pneumatic current that runs between each pair of inflow and outflow channel, if several pairs of such channels distributed across the circumference are planned.

1. Pneumatically driven vibrator with an essentially closed housing (2), in whose operating space, (3) a cylindrically shaped, unbalanced rotor (1) is mounted in bearings in such a fashion as to be capable of rotation, and exhibits a channel for inflow and outflow that is at least tangentially directed in relation to this rotor, so as to allow for an air-driven mode of operation, marked by the fact that the cross-section of the pneumatic stream that flows from every inflow channel, between the exterior surface of the rotor (1) and the inner wall of the operating space (3), should first be steadily reduced-in the direction of the current-down to the narrowest cross-section, and then be steadily increased, up to the corresponding outflow channel.

2. The vibrator according to claim 1, with inflow and outflow channels that are characterized by the fact that the operating space (3) is of circular/cylindrical formation, and by the fact that the axis (6) of the rotor (1) proceeds in parallel fashion, and eccentrically, relative to the axis (7) of the operating space (3).

3. The vibrator according to claim 2, marked by the fact that the axis (6) of the rotor (1) and the axis (7) of the operating space (3) lie on a plane (9a), that-being opposite to a plane that runs in parallel relative to a mounting surface (8) of the housing (2)-is arranged in such as way that it is turned away from the inflow channel (4) onto the outflow channel (5).

4. The vibrator according to claim 3, marked by the fact that the plane (9a), lying opposite to the plane (9), is turned around by 10 to 20 degrees.

5. The vibrator according to any one of claims 2 to 4, characterized by the fact that the eccentricity lies in the region of from 1.5 to 2.5 percent of the diameter of the rotor (1).

6. The vibrator according to claim 1, marked by the fact that the operating space (3a) of the housing (2) is modified in such a way that the cross-section of the pneumatic stream that flows from every inflow channel (4), between the exterior surface of Fe cylinder-shaped rotor (1) and the inner wall of the operating space (3a), should first be reduced-in the direction of the current-down to the narrowest cross-section, and then be steadily increased, up to the corresponding outflow channel (5); and this modification takes place, either by means of an insert, or through an opening opposite a basic design characterized by circularity/cylindricality.

7. The vibrator according to claim 6, with an inflow and an outflow channel, characterized by the fact that the narrowest cross-section lies on a plane (9a), that-being opposite to a plane (9) that runs in parallel relative to a mounting surface (8) of the housing (2)-is arranged in such as way that it is turned away from the inflow channel (4) onto the outflow channel (5).

8. The vibrator according to at least one of claims 1 to 7, marked by the fact that the rotor (1) exhibits bearing pins (1a, 1b), that are mounted in the bores (2a, 2b) of the housing (2), as well as the housing covers (12) by means of ball-bearings (10, 11).

9. The vibrator according to claim 8, marked by the fact that one of the bores (2a) for the reception of the ball-bearing (10) is positioned within the casing itself (2), and that the opposite-lying bore hole (2b) is formed in a cover (12) that is inserted into the casing (2).

10. In keeping with claim 8 or 9, the vibrator, characterized by the fact that the cover (12) is screwed in into the housing or casing (2).

11. The vibrator according to at least one of the claims, 1 to 10, marked by the fact that the rotor (1) exhibits at least one axial bore hole that is arranged eccentrically in relation to its axis, for the collocation of a filling with a specific weight that is greater, as compared with the material of the rotor, and this, for purposes of the initial setting, as well as the subsequent alteration of its unbalance.
